(19) United States
(12) Patent Application Publication
(10) Pub. No.: US 2007/0211817 A1
(43) Pub. Date: Sep. 13, 2007

(54) Computer numerical control wireless transmission System

(75) Inventor: Frank Chen, Taichung City (TW)

Correspondence Address: BIRCH STEWART KOLASCH & BIRCH, PO BOX 747, FALLS CHURCH, VA, 22040-0747, US

(73) Assignee: REN AN INFORMATION TECHNOLOGY CO., LTD.

(21) Appl. No.: 11/373,290

(22) Filed: Mar. 13, 2006

(51) Int. Cl. H04L 27/00

(52) U.S. Cl. 375/295

(57) ABSTRACT

A computer numerical control (CNC) wireless transmission system comprises a direct numerical control (DNC) server, which converts the numerical control program to the radio data for transmission. The DNC server connects to an access point, which has an antenna for the transmission of the numerical control data in radio frequency. The wireless transmitter can receive the radio data transmitted from the antenna of the access point. Furthermore, the wireless transmitter has high mobility, which allows the CNC wireless transmission system itself to have flexible arrangement in positioning.

### BACKGROUND

1. Field of Invention

The present invention relates to a computer numerical control wireless transmission system. More particularly, the present invention relates to a computer numerical control wireless transmission system having a portable wireless transmitter.

2. Description of Related Art

With the developments in modern industrial technology, many ways have been provided for a transmitter to transmit computer numerical control (CNC) program/data between electrical equipment (such as numerical control (NC) program editors and CNC machines) in a CNC wireless transmission system. Generally speaking, a laptop can be used as a transmitter to transmit the CNC program/data by downloading/uploading a CNC program from a numerical control program editor (a master station) in one place, and then the laptop directly connects with a CNC machine (a slave station) in another place as the transmitter to transmit the CNC data by uploading/downloading the CNC program. The laptop provides high mobility and workability as a transmitter, but the cost of the laptop is higher than a conventional wireless transmitter. Therefore, using a laptop as a CNC wireless transmitter raises the cost of one CNC wireless transmission system compared to another CNC transmission system with a conventional wireless transmitter.

As compared to other forms of transmitters, an immobile conventional wireless transmitter is typically fixed on a CNC machine (a slave station) to replace a wired transmitter for the transmission of a numerical control data between the slave station and a master station (such as a numerical control program editor), wherein the immobile conventional wireless transmitter does not have an independent power source. Therefore, the immobile conventional wireless transmitter is often powered by the CNC machine, which connects with the conventional wireless transmitter. In a huge factory with a large number of CNC machines, the arrangement of power lines of the CNC machines is troublesome, restricting the available space of the factory and possibly creating such poor workflow of the equipment that productivity is hampered. Obviously, the positioning of the conventional wireless transmitters without independent power sources is also limited. For example, only one conventional wireless transmitter connects with one CNC machine; therefore, the cost to maintain and repair these conventional wireless transmitters is increased. In addition, extra time and manpower to maintain and repair the immobile conventional wireless transmitters, which are often fixed on the CNG machines, are usually allocated separately.

For the foregoing reasons, there is a need for increasing the mobility while reducing the cost of a CNC wireless transmission system.

### SUMMARY

The present invention is directed to a CNC wireless transmission system, which satisfies the need of increasing the mobility and reducing the cost of a CNC wireless transmission system, wherein the CNC wireless transmission system comprises a direct numerical control (DNC) server, an access point and a portable wireless transmitter.

It is therefore an objective of the present invention to provide a computer numerical control wireless transmission system, which can lower the cost by replacing an expensive mobile transmitter, such as a laptop, and reducing the amount of the transmitters with a portable wireless transmitter.

It is another an objective of the present invention to provide a computer numerical control wireless transmission system, which has mobility and workability by employing a portable wireless transmitter with an independent power source to replace an immobile wireless transmitter with no independent power source. The portable wireless transmitter with an independent power source can increase the flexibility of the positioning of the computer numerical control wireless transmission system.

It is still another objective of the present invention to provide a computer numerical control wireless transmission system, which has a multiplexing portable wireless transmitter. The multiplexing portable wireless transmitter minimizes the amount of the wireless transmitters, which connects with the CNC machines, and additionally economizes on the cost of a computer control wireless transmission system. Furthermore, the efficiency of the maintenance and the repair are both increased.

In accordance with the foregoing and other objectives of the present invention, a computer numerical control wireless transmission system is provided that comprises a direct numerical control (DNC) server, which converts a numerical control data into radio frequency for transmission. An access point connecting with the DNC server has an antenna to telecommunicate the numerical control data in radio frequency. A portable wireless transmitter and the antenna of the access point telecommunicate with each other.

One embodiment of the present invention provides a computer numerical control (CNC) wireless transmission system comprising a direct numerical control (DNC) server, an access point and a portable wireless transmitter. The inexpensive portable wireless transmitter is used to replace the expensive laptop as an adapter. Thus, the advantage of the present invention is that it is more mobile and workable as compared with a CNC wireless transmission system having a laptop as an adapter; and furthermore, it is less expensive than a CNC wireless transmission system having a laptop as a mobile transmitter.

Another embodiment of the present invention provides a CNC wireless transmission system comprising a DNC server, an access point, a portable wireless transmitter and a plurality of electrical equipment. The portable wireless transmitter multitasks to allow the CNC wireless transmission system to connect with a plurality of electrical equipment (CNC tool machines or machines with programmable logic controllers, PLC) by employing only one portable wireless transmitter. In addition, a portable wireless transmitter has at least one independent power source and makes for flexible positioning both for the portable wireless transmitter and a plurality of electrical equipment in a factory. Thus, the available space of the factory is increased.

In conclusion, the invention allows a CNC wireless transmission system of lower installation cost and lower operating cost.

Moreover, the invention allows a CNC wireless transmission system connecting with a plurality of electrical equipment, saving more space of the factory and providing more flexible positioning of electrical equipment in the factory.

It is to be understood that both the foregoing general description and the following detailed description are by examples and are intended to provide further explanation of the invention as claimed.

### BRIEF DESCRIPTION OF THE DRAWINGS

The invention can be more fully understood by reading the following detailed description of the preferred embodiment, with reference made to the accompanying drawings as follows:

FIG. 1 illustrates a block diagram of a computer numerical control wireless transmission system of the present invention in one preferred embodiment.

FIG. 2 shows another block diagram of a CNC wireless transmission system connecting with a numerical control (NC) editor and a plurality of CNC tool machines according to another preferred embodiment of this invention.

### DESCRIPTION OF THE PREFERRED EMBODIMENTS

Reference is now made in detail to the present preferred embodiments of the invention, examples of which are illustrated in the accompanying drawings. Wherever possible, the same reference numbers are used in the drawings and the description to refer to the same or like parts.

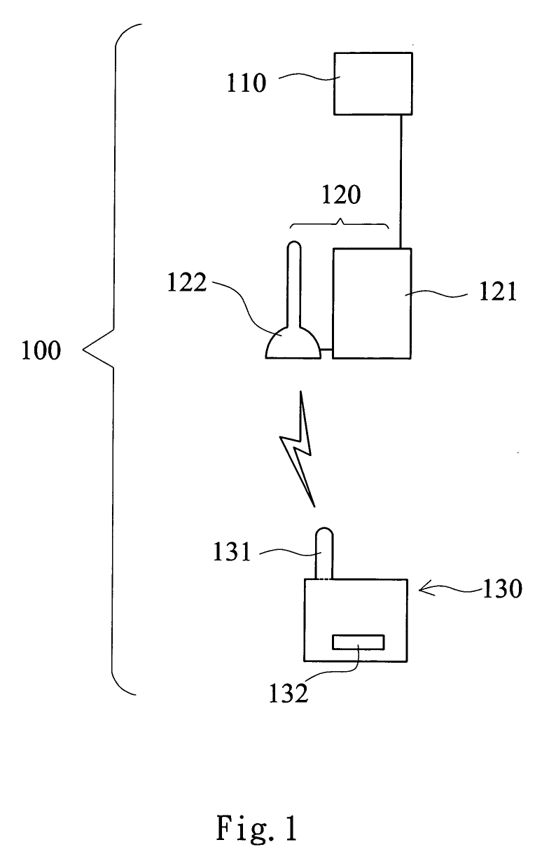

FIG. 1 illustrates a block diagram of a computer numerical control wireless transmission system of the present invention in one preferred embodiment, where the computer numerical control (CNC) wireless transmission system 100 comprises a direct numerical control (DNC) server 110, an access point 120, and a portable wireless transmitter 130.

In another preferred embodiment of the present invention, a DNC server 110 of a CNC wireless transmission system 100 respectively connects with an access point 120 and at least one computer equipment, such as a computer-aided design and computer-aided manufacturing (CAD/CAM) host, to transmit a numerical control (NC) program/data alternatively. The DNC server 110 may be replaced by a multi-port DNC server that multitasks NC programs/data.

In still another preferred embodiment of the present invention, an access point 120 comprises a host 121 and a first antenna 122, where the host 121 respectively connects with the DNC server 110 and the first antenna 122 for transmitting a NC program/data. The first antenna 122 of the access point 120 is, for example, an omni-directional antenna.

In yet another embodiment of the present invention, referring again to the FIG. 1, a portable wireless transmitter 130 comprises a second antenna 131, a serial port 132, an independent power source 133 (not illustrated in FIG. 1) and a wireless control module 134 (not shown in FIG. 1). The portable wireless transmitter 130 connects with other CNC electrical equipment, where the second antenna 131 of the portable wireless transmitter 130 telecommunicates in radio frequency with a first antenna 122 of an access point 120. The aforementioned second antenna 131 is an omni-directional antenna, such as a dipole antenna or a unidirectional antenna. A serial port 132 of a portable wireless transmitter 130 further respectively connects with the wireless control module 134 and an electrical equipment, where the serial port 132 is, for example, a RS-232 or a RS-422 or a RS-485. An independent power source 133 provides the power to the whole portable wireless transmitter 130, and this greatly increases the mobility and the flexibility of positioning the portable wireless transmitter 130.

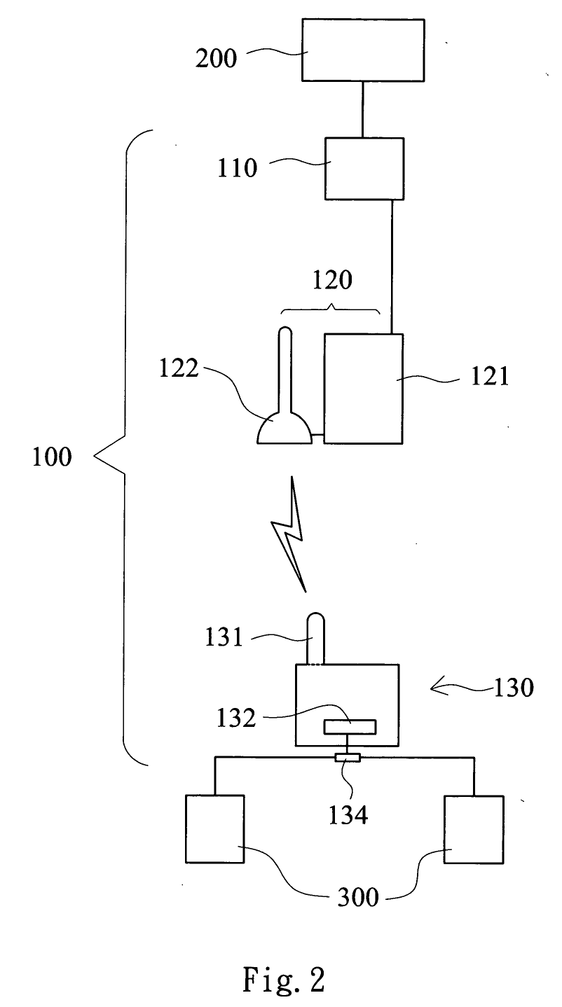

FIG. 2 shows another preferred embodiment of the present invention of a CNC wireless transmission system, where a CNC wireless transmission system 100 respectively connects with a numerical control (NC) editor 200 and at least a CNC tool machine 300.

In the aforementioned CNC wireless transmission system 100, a DNC server 110 respectively connects with the NC editor 200, a numerical control program computer, and an access point (AP) 120. The DNC server 110 is, for example, a multi-port DNC server. In the meantime, a serial port 132 in a portable wireless transmitter 130 of the CNC wireless transmission system 100 connects with an expansion card for linking up with one or more CNC tool machines 300.

It is readily known that the CNC wireless transmission system 100 of the present invention connects with a plurality of electrical equipment, such as CNC tool machines or electrical equipment with programmable logic controllers, by employing a portable wireless transmitter 130 with high mobility and workability. It effectively reduces the cost of equipment, for example, one portable wireless transmitter 130 links up a plurality of CNC tool machines rather than one immobile conventional wireless transmitter linking up with one CNC tool machine. Furthermore, the portable wireless transmitter 130 is more reliable by disposing it in a conditioned location, such as in an air-conditioned room, with its flexibility in positioning. Thus, the convenience and the cost of maintaining and repairing the portable wireless transmitter 130 are readily improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer numerical control wireless transmission system, comprising:
a direct numerical control (DNC) server, converting a numerical control data into radio frequency for transmission;
an access point, connecting with the DNC server; the access point having an antenna for telecommunication of the numerical control data in radio frequency;
a portable wireless transmitter telecommunicating with the antenna.

2. The computer numerical control wireless transmission system of claim 1, further comprising a computer facility connecting directly with the DNC server.

3. The computer numerical wireless transmission system of claim 2, wherein the computer facility is a computer-aided design/computer-aided manufacturing (CAD/CAM) facility.

4. The computer numerical wireless transmission system of claim 2, wherein the computer facility is a numerical control editor (NC-editor).

5. The computer numerical wireless transmission system of claim 1, wherein the DNC server is a multi-port DNC server.

6. The computer numerical wireless transmission system of claim 1, wherein the antenna is an omni-directional antenna.

7. The computer numerical wireless transmission system of claim 1, wherein the portable wireless transmitter comprises:
a transmission antenna, the transmission antenna connecting with a wireless chip module;
a serial adapter, respectively connecting with the wireless chip module and an electrical equipment;
an independent power source, providing power to the portable wireless transmitter.

8. The computer numerical wireless transmission system of claim 7, wherein the transmission antenna is an omni-directional antenna.

9. The computer numerical wireless transmission system of claim 8, wherein the omni-directional antenna is a dipole antenna.

10. The computer numerical wireless transmission system of claim 7, wherein the transmission antenna is a unidirectional antenna.

11. The computer numerical wireless transmission system of claim 7, wherein the electrical equipment is a computer numerical control (CNC) machine.

12. The computer numerical wireless transmission system of claim 7, wherein the electrical equipment is a computer numerical control (CNC) machine.

13. The computer numerical wireless transmission system of claim 7, wherein the electrical equipment is an electrical equipment with a programmable logic controller (PLC).

14. The computer numerical wireless transmission system of claim 7, further comprising an expansion card, the expansion card connecting with the serial port.

15. The computer numerical wireless transmission system of claim 14, wherein the expansion card connects with a plurality of electrical equipment.

16. The computer numerical wireless transmission system of claim 15, wherein the plurality of electrical equipment is a plurality of computer numerical control tool machines.

17. The computer numerical wireless transmission system of claim 7, wherein the serial port is an RS-232.

18. The computer numerical wireless transmission system of claim 7, wherein the serial port is an RS-422.

19. The computer numerical wireless transmission system of claim 7, wherein the serial port is an RS485.

20. The computer numerical wireless transmission system of claim 7, wherein the independent power source is a battery pack.
